(19) United States
(12) Patent Application Publication
(10) Pub. No.: US 2002/0199022 A1
(43) Pub. Date: Dec. 26, 2002

(54) System and method for establishing and managing communications between mangement protocol different system

(76) Inventors: Simon Tsang, Hillsboro, OR (US); Surekha Poola, Beaverton, OR (US); Mahendra Ramachandran, Poaland, OR (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/891,169

(22) Filed: Jun. 26, 2001

(51) Int. Cl. G06F 15/16

(52) U.S. Cl. 709/246

(57) ABSTRACT

A system, method and computer program enabling communications and the exchange of information between a Desktop Management Interface (DMI) network and a Common Information Model (CIM) network. A CIM to DMI provider is utilized to receive events, interrupts, and messages from both the CIM and DMI network and convert these events, interrupts, and messages to the appropriate format for each of the networks. Further, a proxy CIM object manager (CIMOM) is utilized to establish communications with CIM client applications and to interface to the CIM to DMI provider. This system, method and computer program does not require the modification or alteration of an existing DMI network in order to communicate to a CIM network.

### FIELD

The invention relates to a system and method for establishing communications between different communication models employed in different computer systems. More particularly, the present invention enables a common information model (CIM) based protocol to communicate with a desktop management interface (DMI) based protocol.

### BACKGROUND

In the rapid development of computers many advancements have been seen in the areas of processor speed, throughput, communications, and fault tolerance. Initially computer systems were standalone devices in which a processor, memory and peripheral devices all communicated through a single bus. Later, in order to improve performance, several processors were interconnected to memory and peripherals using one or more buses. In addition, separate computer systems were linked together through different communications mechanisms such as, shared memory, serial and parallel ports, local area networks (LAN) and wide area networks (WAN). Further, with the development of the Internet and advancements in cellular and wireless communications, it is now possible for computers to communicate without the use of wires, such as provided by the public switched telephone network (PSTN), over great distances.

In order to facilitate communications between providers of different hardware and software, schemas and standards have been established. Two such schemas are the Desktop Management Interface (DMI) and the Common Information Model (CIM) developed by the Distributed Management Task Force (DMTF). DMI provides a bidirectional path to integrate all hardware and software components within a personal computer (PC). With DMI enabled, a central station in the network may monitor the operations of all PCs therein. Further, data may be transferred from one PC to another utilizing this DMI capability. FIG. 1 is an example implementation of a network utilizing DMI capability. DMI client management applications 10, 20, and 30 communicate to the DMI service provider 40 in order to determine the status and receive information from the DMI component instrumentation 50, 60, and 70. A memory-resident agent (not shown) resides in the background of DMI component instrumentation 50,60, and 70 to respond to queries made by DMI client management applications 10, 20, and 30 via the DMI service provider 40.

Common information model (CIM) is a common data model of an implementation-neutral schema for describing the overall management of information in a network/enterprise environment. FIG. 2 is an example implementation of a network in which communications are established utilizing CIM. In this example, provider A 230 in managed system A 200 through CIM object manager (CIMOM) 260 communicates to CIM client application 320 in CIM client 290, CIM client application 330 in CIM client 300, and CIM client application 340 in CIM client 310. Further in this example, provider B 240 in managed system B 210 through CIMOM 270 communicates to CIM client application 320 in CIM client 290, CIM client application 330 in CIM client 300, and CIM client application 340 in CIM client 310. Still further in this example, provider C 250 in managed system C 220 through CIMOM 280 communicates to CIM client application 320 in CIM client 290, CIM client application 330 in CIM client 300, and CIM client application 340 in CIM client 310. It should be noted that managed system A 200, managed system B 210, managed system C 220, CIM client 290, CIM client 300, and CIM client 310 are all depicted as independent computer systems or processors communicating with each other over a LAN, WAN, PSTN or any other suitable communications mechanism. It should also be noted that CIMOM 260, 270, 280 comprise all software, logic and hardware required for communications.

However, no provision has been made to enable communications between a DMI based network and a CIM network. Therefore, it may be difficult for vendors to persuade customers to migrate from a DMI network to a CIM network since it may entail a software and possibly a hardware upgrade or replacement of existing software and hardware.

Therefore, what is required is a system and method whereby a customer may retain his existing DMI based network while acquiring CIM equipment and establishing communications between the DMI based equipment and the CIM based equipment. This system and method should be simple and cost-effective to implement which would further encourage customers to migrate to the newer CIM standard.

### BRIEF DESCRIPTION OF THE DRAWINGS

The foregoing and a better understanding of the present invention will become apparent from the following detailed description of exemplary embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto. The spirit and scope of the present invention are limited only by the terms of the appended claims.

The following represents brief descriptions of the drawings, wherein:

FIG. 1 is an example of the prior art in Desktop Management Interface (DMI) communications;

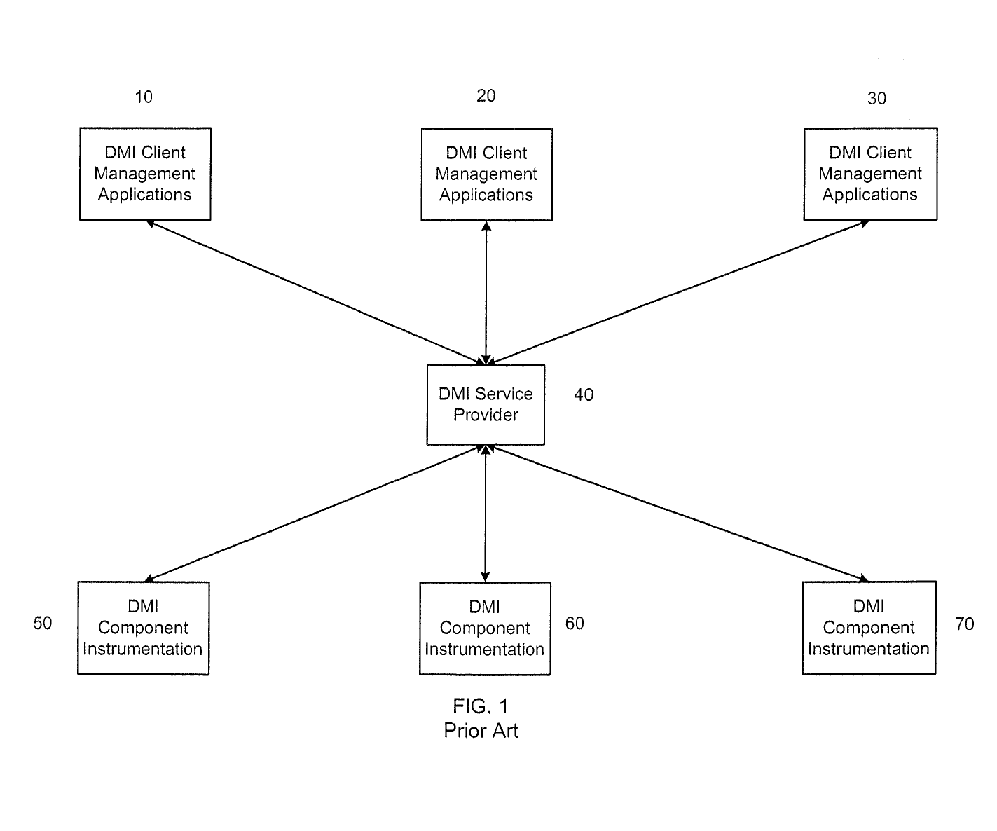

FIG. 2 is an example of the prior art in Common Information Model (CIM) communications;

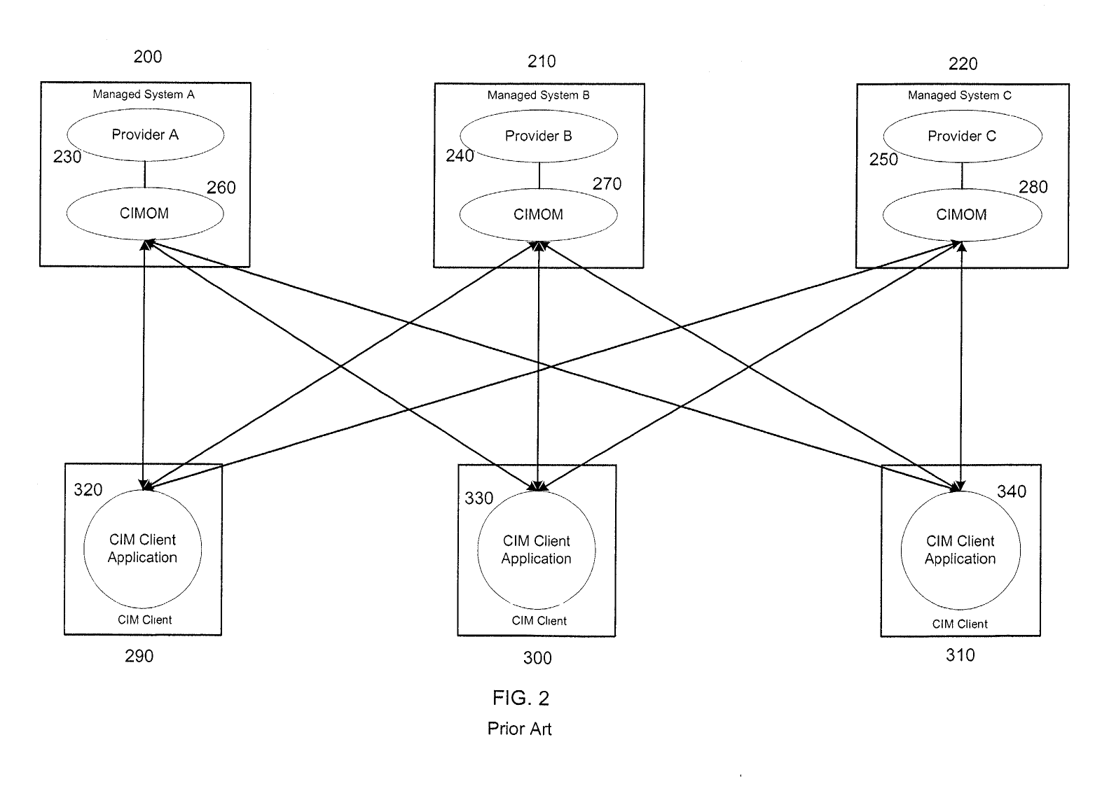

FIG. 3 is a systems diagram for an example embodiment of the present invention;

FIG. 4 is a flowchart of the logic involved in the instantiation of object classes requested by a CIM client application to a DMI system management stack in an example embodiment of the present invention;

FIG. 5 is a flowchart of the logic involved in DMI event processing delivered to a CIM client application via a CIM to DMI provider 40 in an example embodiment of the present invention;

FIG. 6 is a flowchart of the overall registration, monitoring, and translation process used in an example embodiment of the present invention;

FIG. 7 is a flowchart illustrating the processing required for a DMI event occurrence in an example embodiment of the present invention;

FIG. 8 is a flowchart illustrating the processing involved in a CIM client request occurrence in an example embodiment of the present invention; and

FIG. 9 is a data flow diagram illustrating the major modules involved in the operations depicted in the flowcharts shown in FIGS. 4-8 in an example embodiment of the present invention.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, exemplary sizes/models/values/ranges may be given, although the present invention is not limited to the same. As a final note, well-known components of computer networks may not be shown within the FIGs. for simplicity of illustration and discussion, and so as not to obscure the invention.

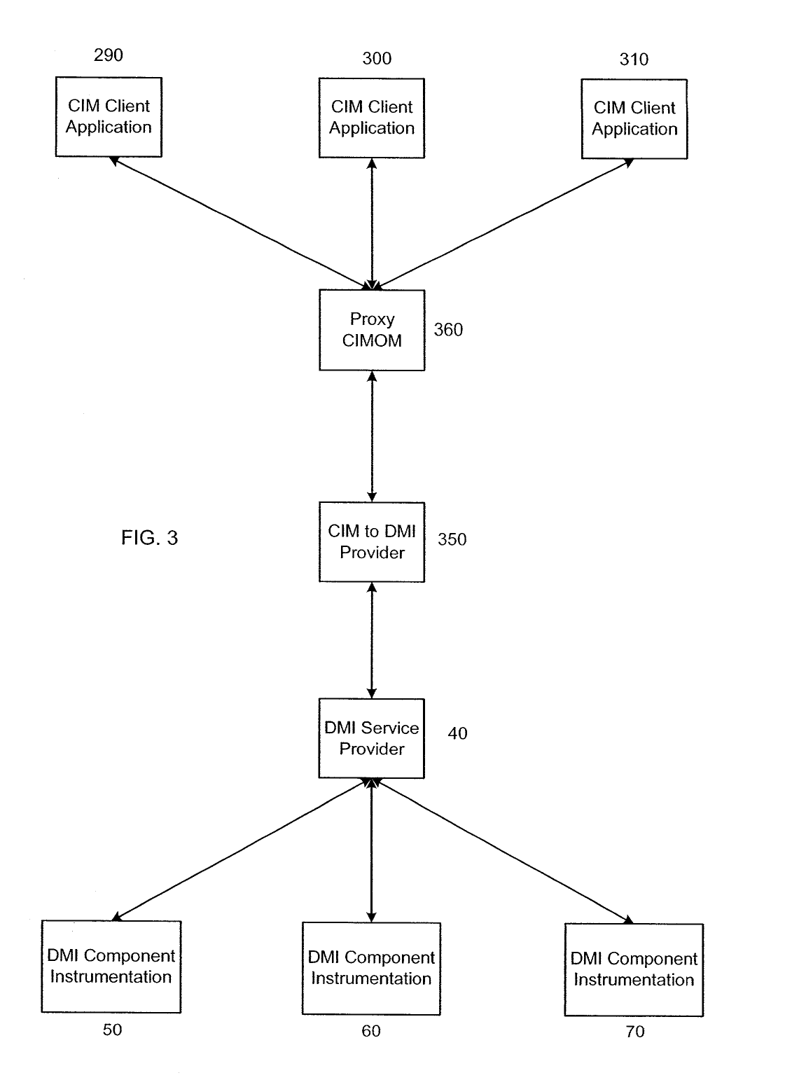

FIG. 3 is a systems diagram for an example embodiment of the present invention. The systems diagram shown in FIG. 3 may be divided into three distinct layers. The first layer is the DMI system management stack and comprises the DMI component instrumentation 50, 60, and 70 as well as the DMI service provider 40. The second layer is the CIM client stack and comprises the CIM client applications 290, 300, and 310. The third layer is the partial CIM stack comprising a CIM to DMI provider 350 and proxy CIMOM (common information model object module) 360. The proxy CIMOM 360 performs the same function as the CIMOM 260, 270, and 280 with the exception that it is now moved to a separate server and can handle requests from separate CIM applications 290, 300, and 310. In this manner the proxy CIMOM 360 serves to off load the managed systems 200, 210, and 220 from requiring their own CIMOM.

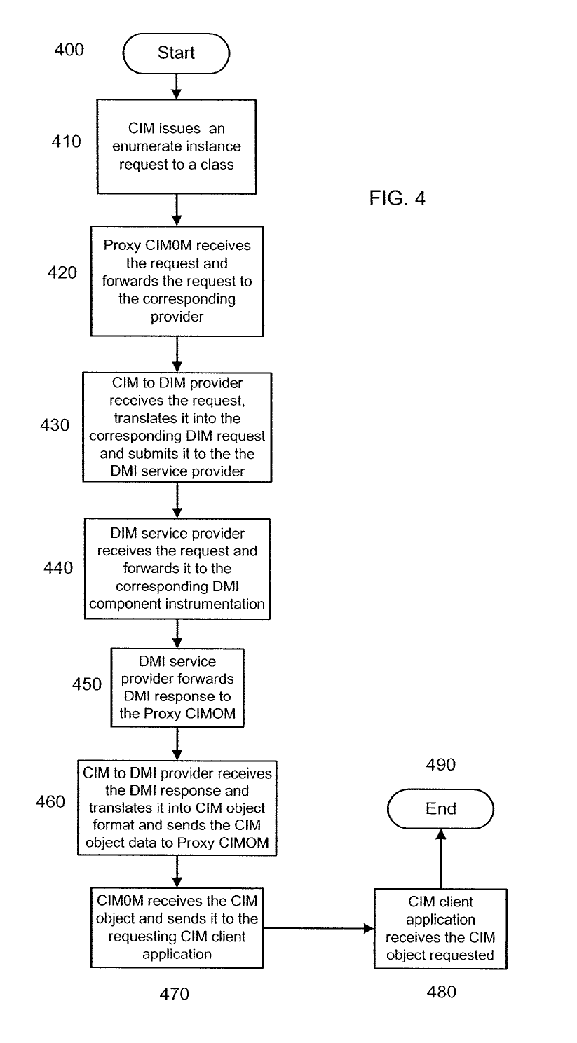

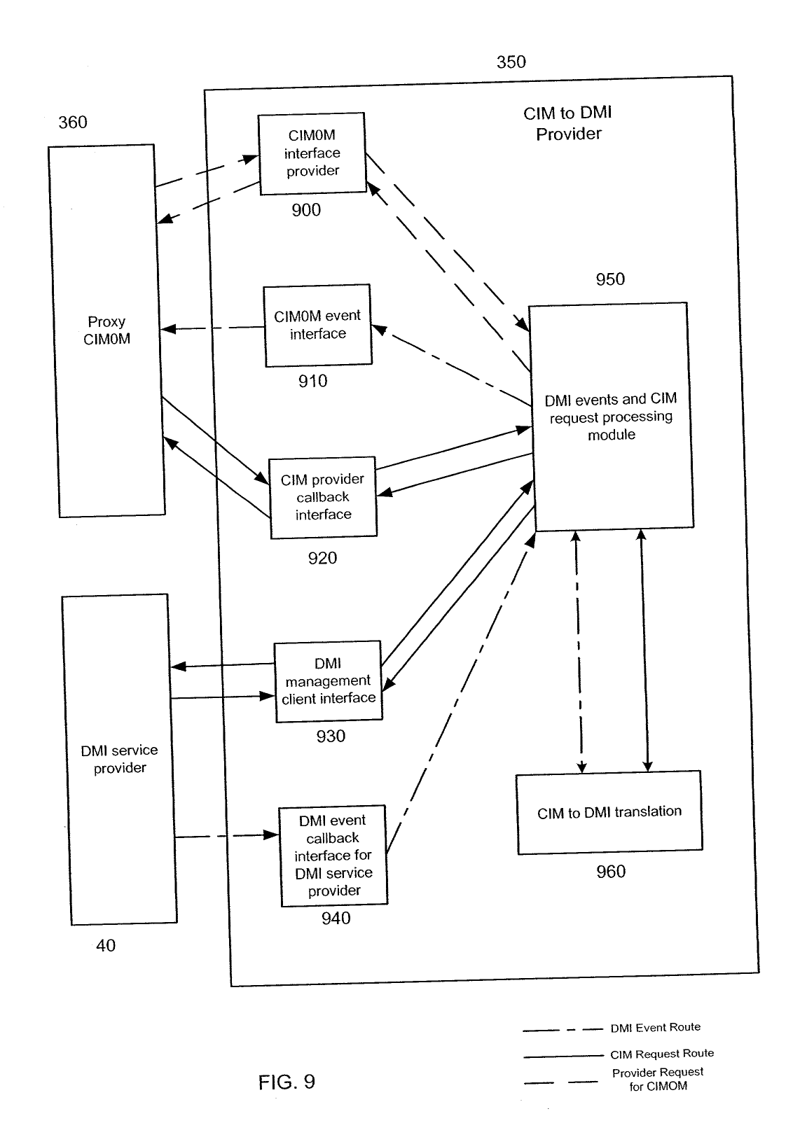

Still referring to FIG. 3, the CIM to DMI provider 350 serves to translate and reformat messages sent between the proxy CIMOM 360 and the DMI service provider 40. Utilizing the CIM to DMI provider 350 it is possible to interface a DMI based network with a CIM based network, thereby enabling the supportable standards within a single LAN (local area network). The operation of the CIM to DMI provider 350 is further detailed in the flowcharts illustrated in FIGS. 4-8 and the data flow between modules in the CIM to DMI provider 350 is further discussed in reference to FIG. 9.

Before proceeding into a detailed discussion of the logic used by the embodiments of the present invention it should be mentioned that the flowcharts shown in FIGS. 4 through 8 as well as the modular configuration diagram shown in FIG. 9 contain software, firmware, hardware, processes or operations that correspond, for example, to code, sections of code, instructions, commands, objects, hardware or the like, of a computer program that is embodied, for example, on a storage medium such as floppy disk, CD Rom, EP Rom, RAM, hard disk, etc. Further, the computer program can be written in any language such as, but not limited to, for example C++. In the discussion of the flowcharts in FIGS. 4 through 8, reference will be simultaneously made to the corresponding software modules shown in FIG. 9.

FIG. 4 is a flowchart of the logic involved in the instantiation of object classes requested by a CIM client application to a DMI server management stack in an example embodiment of the present invention. The logic illustrated in FIG. 4 is executed by the CIMOM interface provider 900 and a DMI events and CIM request processing module 950, shown in FIG. 9. The CIM interface provider 900 begins execution in operation 400 and immediately proceeds to operation 410. In operation 410, a CIM client 290, 300, or 310 issues an enumerate instance request to a class of objects contained within the CIM to DMI provider 350. In operation 420, the proxy CIMOM 360 receives the request and forwards it to the corresponding CIM to DMI provider 350. Thereafter, in operation 430, the CIM to DMI provider 350 receives the request and translates it into the corresponding DMI request and transmits it to the DMI service provider 40. In operation 440, the DMI service provider 40 receives a request and forwards it the corresponding DMI component instrumentation 50,60, and 70. Upon receipt of a response from the DMI component instrumentation 50, 60, or 70, the DMI service provider 40 forwards it the CIM to DMI provider 350, in operation 450. Processing then proceeds to operation 460 where the CIM to DMI provider 350 receives a DMI response and translates it into CIM object format and transmits the CIM object data to the proxy CIMOM 360. In operation 470, CIMOM receives the CIM object and sends it to the requesting CIM client application 290, 300, and 310. Thereafter, in operation 490 the CIM client application receives a CIM object requested and thereafter, in operation 490, processing terminates for the CIM interface provider module 900.

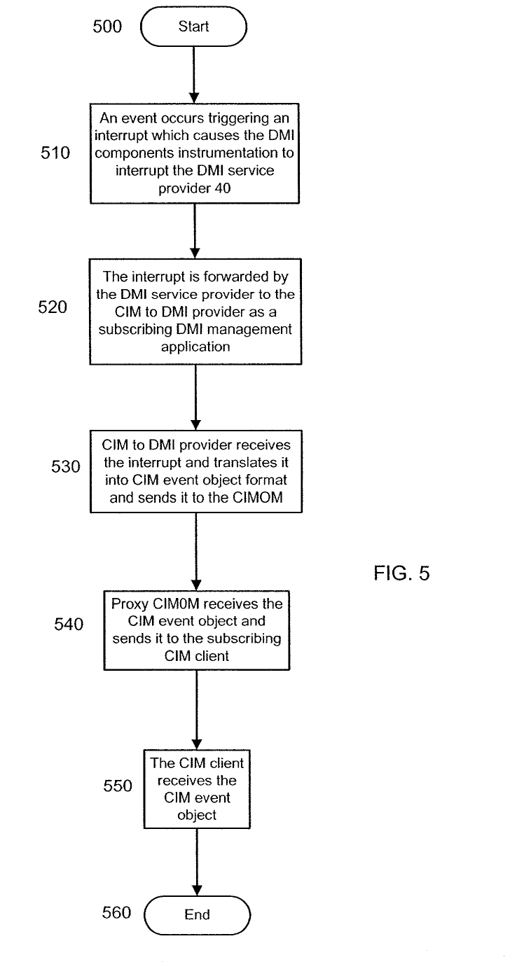

FIG. 5 is a flowchart of the of the logic involved in DMI event processing delivered to a CIM client application via a CIM to DMI provider 40 as executed by a DMI events and CIM request processing module 950 using a DMI event callback interface 940 and a CIMOM event interface 910, shown in FIG. 9, in an example embodiment of the present invention. The DMI events and CIM request processing module 950 begins execution in operation 500 and immediately proceeds to operation 510. In operation 510 an event occurring in the DMI component instrumentation 50, 60, and 70 causes an interrupt to be generated in the DMI service provider 40. Thereafter, in operation 520, the interrupt is forwarded by the DMI service provider 40 to the CIM to DMI provider 350 where the DMI events and CIM request processing module 950 resides. The DMI event callback interface 940 first receives the interrupt and passes it to the DMI events and CIM request processing module 950. Thereafter, in operation 530, the interrupt is translated by the CIM to DMI translation module 960 into a CIM event object which is then transmitted via the CIMOM event interface 910 to the proxy CIMOM 360. In operation 550, the proxy CIMOM 360 receives the CIM event object and transmits it to the appropriate CIM client application 290, 300, or 310. Thereafter, processing terminates in operation 560.

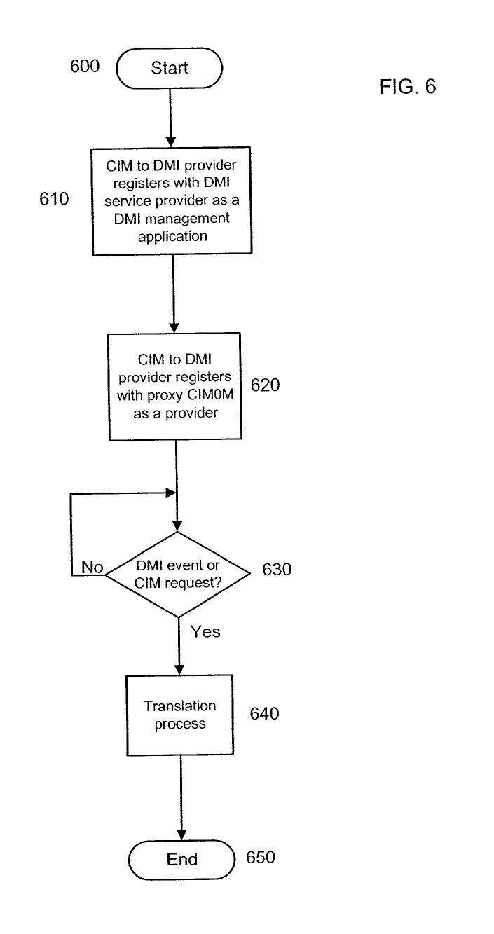

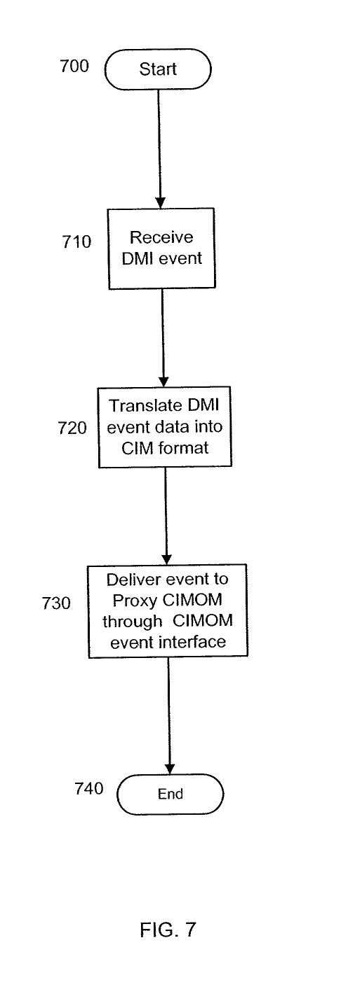

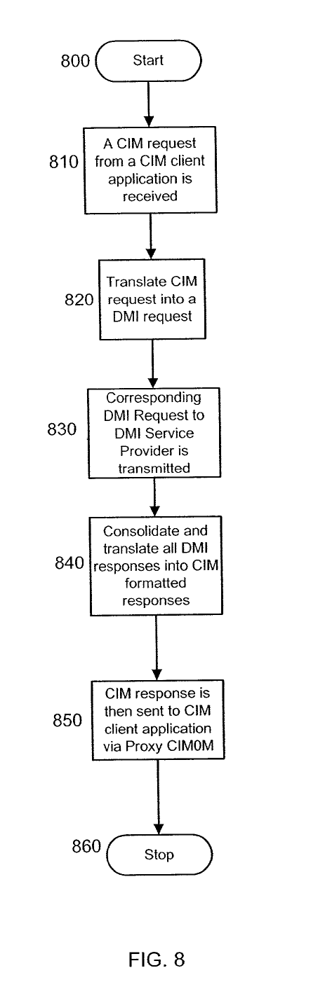

FIG. 6 is a flowchart of the overall registration, monitoring, and translation process executed by the DMI events and request processing module 950 using the CIMOM interface 900 and the DMI management client interface 930, as shown in FIG. 9, used in an example embodiment of the present invention. The DMI events and CIM request processing module 950 begins execution in operation 600 and immediately proceeds to operation 610. In operation 610, CIM client application 290, 300, or 310 registers with the DMI service provider 40 via the proxy CIMOM 360 via the CIM to DMI provider 350. This registration process entails registering the CIM to DMI provider 350 as a DMI management application. Thereafter, processing proceeds to operation 620 where CIM to DMI provider 350 registers with the proxy CIMOM 360 as a provider application. In operation 630, it is determined if a DMI event or a CIM request has occurred. If either a DMI event or a CIM request has not occurred then processing loops back to operation 630 until such an event or request does occur. However, if a DMI event or CIM request has occurred then processing proceeds to operation 640 where the CIM to DMI translation module 960, shown in FIG. 9, translates the event or request into the proper format. The logic involved in processing a DMI event is further detailed in the discussion referencing FIG. 7. The logic involved in processing a CIM client request is further detailed discussion provided in reference to FIG. 8. Thereafter, processing proceeds to operation 650 where processing terminates.

FIG. 7 is a flowchart illustrating the processing required for a DMI event occurrence as executed by the DMI events and request processing module 950 using the DMI event callback interface module 940 in an example embodiment of the present invention. Processing begins in operation 700 and immediately proceeds operation 710. In operation 710 the DMI service provider 40 receives an event from a DMI component instrumentation 50, 60, or 70 and transmits that event to the CIM to DMI provider 350. More specifically the DMI event callback interface module 940 receives the event and transmits it to the DMI events and CIM request processing module 950, shown in FIG. 9. Thereafter, in operation 720, the DMI events and CIM request processing module 950 utilizes the CIM to DMI translation module 960 to translate the DMI event data into the CIM format. In operation 730 the DMI events and CIM request processing module 960 transmits the event to the proxy CIMOM 360 utilizing the CIMOM event interface 910. Thereafter, processing terminates in operation 740.

FIG. 8 is a flowchart illustrating the processing involved in a CIM client request occurrence executed by the CIM provider callback module 920 and the DMI management client interface module 930 in an example embodiment of the present invention. Processing begins in operation 800 and immediately precedes to operation 810. In operation 810, the CIM to DMI provider 350 receives a CIM request via the CIMOM interface 900. This CIM request was transmitted by the proxy CIMOM 360 and was initially generated by a CIM client application 290, 300, or 310. In operation 820, the DMI events and CIM request processing module 950 utilizes the CIM to DMI translation module 960 to translate the CIM request into a DMI request. Thereafter, in operation 830 a corresponding DMI request to the DMI service provider 40 is transmitted via the DMI management client interface 930. In operation 840, all DMI responses received from the DMI service provider 40 are consolidated and translated into CIM responses by the DMI events and CIM request processing module 950. Thereafter, in operation 850 the CIM response is then sent to the CIM client application 290, 300, or 310 via the proxy CIMOM 360. Processing then terminates in operation 860.

FIG. 9 is a data flow diagram illustrating the major modules involved in the operations depicted in the flowcharts shown in FIGS. 4-8 in an example embodiment of the present invention. Three major components are depicted in FIG. 9 including the proxy CIMOM 360, the DMI service provider 40, and the CIM to DMI provider 350. Within the CIM to DMI provider 350 is contained the DMI events and CIM request processing module 950 which indirectly fields all DMI events and CIM requests received. Since the modules depicted in FIG. 9 have been previously discussed in detail in reference to FIGS. 3-8, only the data flow between modules will be discussed in reference to FIG. 9. Three types of data flow operation occur in reference to FIG. 9 that include a DMI event route, a CIM request route, and a provider request for the proxy CIMOM 360. Provider requests received by the proxy CIMOM 360 are transmitted to the CIMOM interface provider 900 and there to the DMI events and CIM request processing module 950. Thereafter, the DMI events and CIM request processing module 950 may, via the DMI management client interface 930, transmit these request to the DMI service provider 40 after translation via the CIM to DMI translation module 960. DMI events transmitted by the DMI service provider 40 are transmitted to the DMI event callback interface for DMI service provider 940 and then to the DMI events and CIM request processing module 950. Thereafter, these DMI events are translated to CIM format using a CIM to DMI translation module 960. In turn the DMI events and CIM request processing module would, via the CIMOM event interface 910, transmit the DMI event, now translated, to the proxy CIMOM 360. Finally, CIM requests are generated by the proxy CIMOM 360 and transmitted to the CIM provider callback interface 920 which in turn transmits them to the DMI events and CIM request processing module 950 for translation by the CIM to DMI translation module 960 and transmission to the DMI service provider 40 via the DMI management client interface 930.

The benefit resulting from the present invention is that a simple, reliable, fast system and method is provided for CIM and DMI based networks to communicate to each other. Further, a computer user with an existing DMI network does not require the replacement or modification of that network in order to communicate with a CIM based computer network.

While we have shown and described only a few examples herein, it is understood that numerous changes and modifications as known to those skilled in the art could be made to the example embodiment of the present invention. Therefore, we do not wish to be limited to the details shown and described herein, but intend to cover all such changes and modifications as are encompassed by the scope of the appended claims.

We claim:

1. A system for communications between computers in a CIM and DMI network, comprising:
a proxy CIMOM in communications with a plurality of CIM client applications;
a DMI service provider in communications with a plurality of DMI component instrumentation;
a CIM to DMI provider connected to the proxy CIMOM and the DMI service provider to register the plurality of CIM client applications and the plurality of DMI component instrumentation, receive events from the DMI service provider, receive interrupts from the proxy CIMOM, receive information from both the proxy CIMOM and the DMI service provider and translate all said interrupts, said events, and said information into a format suitable for an intended recipient, wherein said intended recipient may be either the proxy of CIM client applications or the plurality of DMI component instrumentation.

2. The system recited in claim 1, wherein the CIM to DMI provider further comprises:
a DMI events and CIM requests processing module to register the plurality of CIM client applications and the plurality of DMI component instrumentation, receive events from the DMI service provider, receive interrupts from the proxy CIMOM, receive information from both the proxy CIMOM and the DMI service provider.

3. The system recited in claim 2, wherein the CIM to DMI provider further comprises:
a CIM to DMI translation module connected to the DMI events and CIM requesting module to translate DMI requests and messages to CIM objects and to translate CIM objects to DMI requests and messages.

4. The system recited in claim 3, wherein the CIM to DMI provider further comprises:
a CIMOM interface provider connected to the proxy CIMOM and the DMI events and CIM requests processing module to receive CIM client application requests and transmit the CIM client application requests to the DMI events and CIM request processing module and receive CIM objects from the DMI events and CIM requests processing module and transmit the CIM objects to the proxy CIMOM.

5. The system recited in claim 3, wherein the CIM to DMI provider further comprises:
a DMI event callback interface module connected to the DMI service provider and the DMI events and CIM requests processing module to receive DMI events and transmit the DMI events to the DMI events and CIM requests processing module.

6. The system recited in claim 5, wherein the CIM to DMI provider further comprises:
a CIMOM event interface connected to the proxy CIMOM and the DMI events and CIM requests processing module to transmit CIM interrupts to the proxy CIMOM translated from the DMI events received by the DMI event callback interface and transmitted by the DMI events and CIM requests processing module using the CIM to DMI translation module.

7. The system recited in claim 3, wherein the CIM to DMI provider further comprises:
a CIM provider callback interface connected to the proxy CIMOM and the DMI events and CIM requests processing module to receive CIM requests from the plurality of CIM client applications and transmit them to the DMI events and CIM requests processing module and to transmit to the proxy CIM all the translated DMI events received from the DMI events and CIM requests processing module.

8. The system recited in claim 7, wherein the CIM to DMI provider further comprises:
a DMI management client interface connected to the DMI service provider and the DMI events and CIM requests processing module to receive DMI requests from the DMI service provider and transmit them to the DMI events and CIM request processing module and receive from the DMI events and CIM requests processing module CIM requests translated into DMI format and transmitting the DMI formatted CIM requests to the DMI service provider.

9. A method of communicating between computers in a CIM network and a DMI network, comprising:
instantiating an object request for a class by a CIM client application;
transmitting the object request to a proxy CIMOM that relays the object request to a CIM to DMI provider;
translating the object request to a DMI request; and
transmitting to the DMI request to a DMI component instrumentation via a DMI service provider.

10. The method recited in claim 9, further comprising:
transmitting an event generated by the DMI component instrumentation to the CIM to DMI provider via the DMI service provider;
translating the event into a CIM interrupt; and
transmitting the CIM interrupt to a CIM client application via a proxy CIMOM.

11. The method recited in claim 9, further comprising:
registering a CIM to DMI provider with a DMI service provider as a DMI management application;
receiving a DMI event or CIM request;
translating the DMI event into a CIM interrupt or the CIM request into a DMI request; and
transmitting the translated CIM interrupt to the CIM client application or the translated DMI request to the DMI component instrumentation.

12. The method recited in claim 9, wherein translating the object request to a DMI request is done by a CIM to DMI translation module.

13. A computer program embodied on a computer readable medium executable by a computer, comprising:
instantiating an object request for a class by a CIM client application;
transmitting the object request to a proxy CIMOM that relays the object request to a CIM to DMI provider;
translating the object request to a DMI request; and
transmitting the DMI request to a DMI component instrumentation via a DMI service provider.

14. The computer program recited in claim 13, further comprising:
transmitting an event generated by the DMI component instrumentation to the CIM to DMI provider via the DMI service provider;
translating the event into a CIM interrupt; and
transmitting the CIM interrupt to a CIM client application via a proxy CIMOM.

15. The computer program recited in claim 13, further comprising:
registering a CIM to DMI provider with a DMI service provider as a DMI management application;
receiving a DMI event or CIM request;
translating the DMI event into a CIM interrupt or the CIM request into a DMI request; and
transmitting the translated CIM interrupt to the CIM client application or the translated DMI request to the DMI component instrumentation.

16. The computer program recited in claim 13, wherein translating the object request to a DMI request is done by a CIM to DMI translation module.
